(19) United States
(12) Patent Application Publication
(10) Pub. No.: US 2021/0187647 A1
(43) Pub. Date: Jun. 24, 2021

(54) ARC WELDING ROBOT SYSTEM

(71) Applicant: FANUC CORPORATION, Yamanashi (JP)

(72) Inventors: Shun KOTERA, Yamanashi (JP); Shigeo YOSHIDA, Yamanashi (JP); Hiroshi ONIZAKI, Yamanashi (JP)

(73) Assignee: FANUC CORPORATION, Yamanashi (JP)

(21) Appl. No.: 17/100,727

(22) Filed: Nov. 20, 2020

(30) Foreign Application Priority Data
Dec. 18, 2019 (JP) 2019-228142

(51) Int. Cl. B23K 9/095; B25J 9/16; G05B 19/4155

(52) U.S. Cl. CPC B23K 9/0953; B25J 9/161; B25J 11/005; B23K 9/0956; G05B 19/4155; B25J 9/1674

(57) ABSTRACT

To provide an arc welding robot system that allows for optimal welding each time welding is performed even in a situation in which the impedance and the inductance of a welding circuit vary in each welding. An arc welding robot system includes an arc welding machine, a robot controller, and a parameter keeping device provided in either or both of the robot controller and the arc welding machine. An impedance and an inductance of a welding circuit are acquired in advance for each configuration of welding object and saved in the parameter keeping device. The robot controller performs welding control on each of the welding objects based on the impedance and the inductance saved in the parameter keeping device depending on the configuration of the welding object.

This application is based on and claims the benefit of priority from Japanese Patent Application No. 2019-228142, filed on 18 Dec. 2019, the content of which is incorporated herein by reference.

### BACKGROUND OF THE INVENTION

### Field of the Invention

The present disclosure relates to an arc welding robot system.

### Related Art

Conventionally, arc welding for joining metal materials together by utilizing arcing has been often used in various technical fields such as automobiles, railroad vehicles, watercraft, aircraft, and buildings. Furthermore, as is known, a technique to automate welding in a production line or the like by controlling operation of a robot having a welding torch attached thereto has been in practical use (see, for example, Japanese Unexamined Patent Application (Translation of PCT Application), Publication No. 2019-505391, Japanese Unexamined Patent Application, Publication No. 2018-058117, Japanese Unexamined Patent Application, Publication No. 2017-064805, Japanese Unexamined Patent Application, Publication No. 2017-056487, and Japanese Unexamined Patent Application, Publication No. 2013-071180).

It is to be noted here that during arc welding, a welding circuit closes and current flows due to arcing between a tip of a welding wire and a welding object. The impedance (resistance) and the inductance (induction coefficient) of the welding circuit are important parameters that affect arc stability, spatter yield, and welding quality. Designing an arc welding robot system therefore involves designing an optimal welding circuit by checking, for example, whether or not the diameter and the length of power cables are suitable, whether or not wiring avoids winding of the power cables, and whether or not the welding grounding location is suitable while measuring these parameters. Designing an arc welding robot system also involves adjusting welding conditions such as a command current value and a command voltage value.

Patent Document 1: Japanese Unexamined Patent Application (Translation of PCT Application), Publication No. 2019-505391

Patent Document 2: Japanese Unexamined Patent Application, Publication No. 2018-058117

Patent Document 3: Japanese Unexamined Patent Application, Publication No. 2017-064805

Patent Document 4: Japanese Unexamined Patent Application, Publication No. 2017-056487

Patent Document 5: Japanese Unexamined Patent Application, Publication No. 2013-071180

### SUMMARY OF THE INVENTION

Meanwhile, a welding machine has recently been in practical use that is capable of measuring the above-described parameters and performing optimal welding control based on the results of the measurement.

However, values of the above-described parameters are not always uniquely determined for an arc welding robot system because welding objects can have, for example, different sizes and shapes. Furthermore, a welding system can include a plurality of welding fixtures configured to be movable by being on a rail or the like.

A conventional way to deal with such situations is by applying values of the parameters for a certain configuration to all configurations or by determining values of the parameters for each of the different configurations and using intermediate values. However, such a method does not allow for welding based on optimal values of the parameters in all cases.

An arc welding robot system according to an aspect of the present disclosure includes a robot, an arc welding machine, a robot controller, and a parameter keeping device provided in either or both of the robot controller and the arc welding machine. In this configuration, an impedance and an inductance of a welding circuit are acquired in advance as parameters for each configuration of welding object and saved in the parameter keeping device, and the robot controller performs welding control on each of the welding objects based on the impedance and the inductance saved in the parameter keeping device depending on the configuration of the welding object.

The arc welding robot system according to the above-described aspect of the present disclosure allows for optimal welding each time welding is performed even in a situation in which the impedance and the inductance of the welding circuit vary in each welding. This makes it possible to achieve an improvement in arc stability, a reduction in spatter yield, and an improvement in welding quality.

### BRIEF DESCRIPTION OF THE DRAWINGS

FIG. 1 illustrates an arc welding robot system according to an embodiment;

FIG. 2 illustrates the arc welding robot system according to the embodiment;

FIG. 3 is a diagram showing a procedure for arc welding that is performed using the arc welding robot system according to the embodiment; and

FIG. 4 is a diagram showing a procedure for arc welding that is performed using the arc welding robot system according to the embodiment.

### DETAILED DESCRIPTION OF THE INVENTION

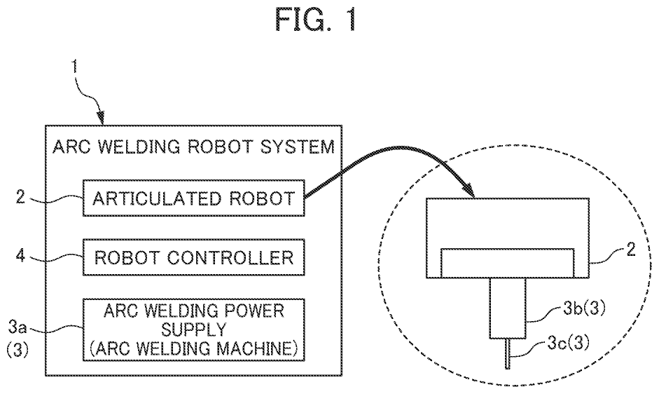

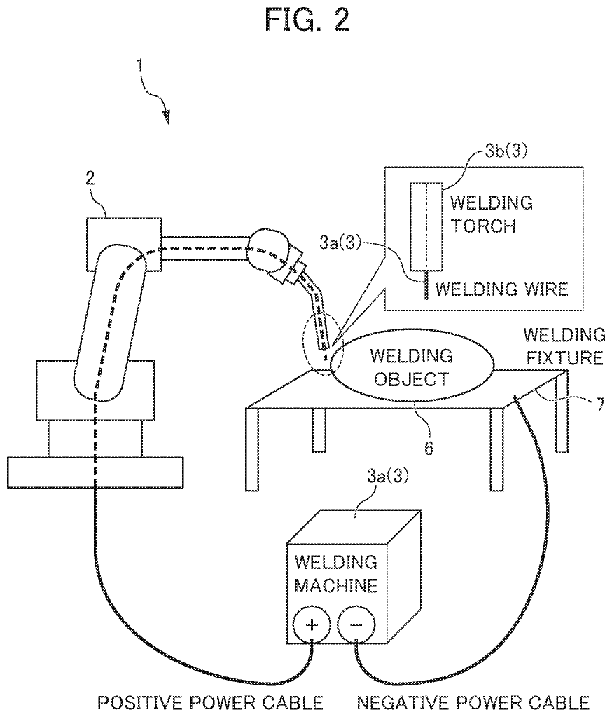

The following describes an arc welding robot system according to an embodiment with reference to FIGS. 1 to 4.

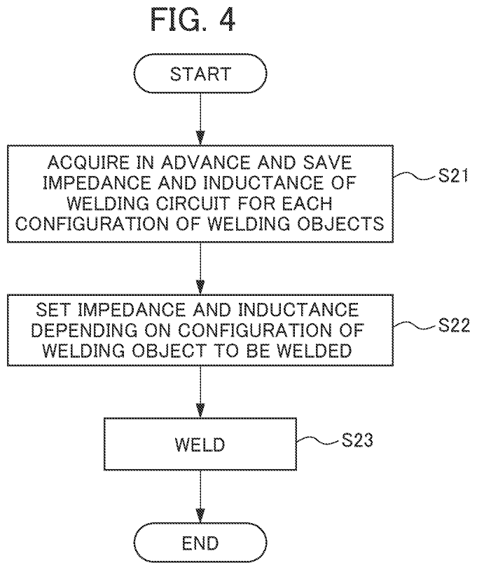

An arc welding robot system 1 according to the present embodiment is, for example, to be included in a production line and perform arc welding on workpieces (welding objects) such as automotive bodies. As illustrated in FIGS. 1 to 4, the arc welding robot system 1 includes a robot 2, a robot controller 4, an arc welding machine 3, and a parameter keeping device 5. The arc welding machine 3 includes an arc welding power supply 3a, a welding torch 3b, and a welding wire 3c. The parameter keeping device 5 is provided in either or both of the robot controller 4 and the arc welding machine 3. In this configuration, an impedance and an inductance of a welding circuit are acquired in advance as parameters for each configuration of welding object 6 and saved in the parameter keeping device 5, and the robot controller 4 controls welding of each of the welding objects 6 based on the impedance and the inductance saved in the parameter keeping device 5 depending on the configuration of the welding object 6 (see Steps S21 to S23 in FIG. 4).

Furthermore, the arc welding robot system 1 according to the present embodiment has the following configuration. That is, in a case where the parameter keeping device 5 provided in the arc welding machine 3 keeps a plurality of sets of values of the parameters and the arc welding machine is to perform welding control based on the parameters, the robot controller 4 specifies a set to be used among the plurality of sets for welding control. In a case where the arc welding machine 3 does not keep a plurality of sets of values of the parameters and the arc welding machine 3 is to perform welding control based on a single set of values of the parameters, the parameter keeping device 5 provided in the robot controller 4 keeps a plurality of sets of values of the parameters and transmits, to the arc welding machine 3, a set to be used among the plurality of sets for welding control.

Alternatively, the arc welding robot system 1 according to the present embodiment has the following configuration. That is, in a case where the robot controller 4 keeps a plurality of sets of values of the parameters and the arc welding machine 3 is not to perform welding control based on the parameters, the robot controller 4 calculates optimal welding command values such as a welding current value, a peak value and a base value in a welding current waveform based on a set to be used among the plurality of sets, and transmits the optimal welding command values to the arc welding machine 3 for welding control.

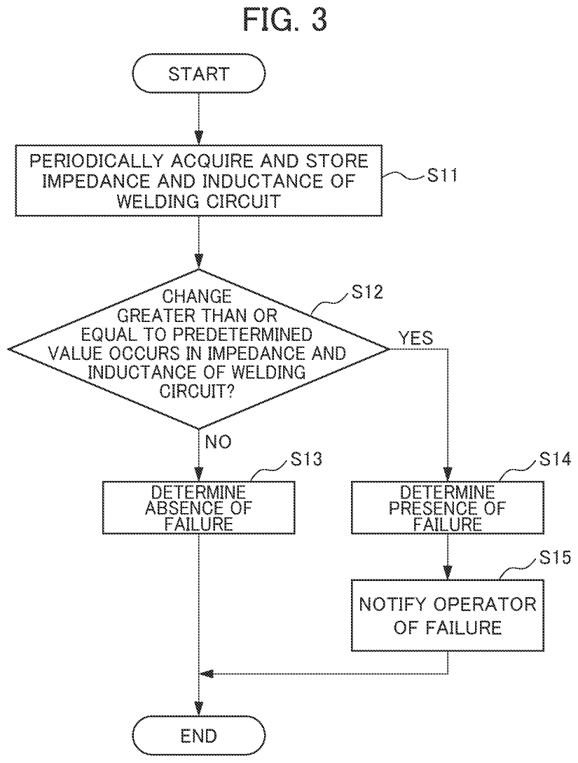

The parameter keeping device 5 periodically acquires and saves the impedance and the inductance of the welding circuit. In this configuration, the arc welding robot system 1 includes a failure determination section that determines the presence of a failure in the welding circuit when a change greater than or equal to a predetermined value occurs in the impedance and the inductance saved in the parameter keeping device 5, and notifies an operator of the failure (see Steps S11 to S15 in FIG. 3).

It is to be noted that the impedance and the inductance saved in the parameter keeping device 5 are those acquired when welding is performed or those acquired when welding is not performed by moving the robot 2 and bringing a tip of the welding wire 3c included in the arc welding machine 3 into contact with any of the welding objects 6.

In the arc welding robot system 1 according to the present embodiment, either or both of the robot controller 4 and the arc welding machine 3 (the arc welding power supply 3a in the present embodiment) are able to keep a plurality of sets of values of the parameters, and it is possible to switch sets to be used among the plurality of sets as desired.

For example, in a case where welding is performed on welding object 6 of type A and type B, the parameters are measured for each type A and type B to obtain a set of values A′ and B′. Then, either or both of the robot controller 4 and the arc welding power supply 3a keep the two sets of values A′ and B′.

In this case, the arc welding robot system 1 makes “preparations” for the use of set A′ for performing welding on type A and for the use of set B′ for performing welding on type B.

The “preparations” vary depending on whether or not the arc welding machine 3 is able to perform the optimal welding control based on the parameters. In a case where the arc welding machine 3 is able to perform welding control and the arc welding machine 3 is also able to keep a plurality of sets of values of the parameters, the robot controller 4 only needs to give the arc welding machine a command to specify which set is to be used among the plurality of sets.

In a case where the arc welding machine 3 is able to perform welding control but the arc welding machine 3 is unable to keep the parameters (or the arc welding machine 3 is only able to keep a single set of values of the parameters), the robot controller 4 keeps a plurality of sets of values of the parameters and transmits, to the arc welding machine 3, a set to be used among the plurality of sets.

In a case where the arc welding machine 3 is unable to perform welding control and the robot controller 4 keeps a plurality of sets of values of the parameters, the robot controller 4 may calculate optimal welding command values (various welding parameter values such as a welding current value, a peak value and a base value in a welding current waveform) based on a set to be used among the plurality of sets and transmit the optimal welding command values to the arc welding machine 3.

Thereafter, in the arc welding robot system 1 according to the present embodiment, welding is performed on type A based on a set of values of the parameters optimal for type A, and welding is performed on type B based on a set of values of the parameters optimal for type B.

Thus, the arc welding robot system 1 according to the present embodiment allows for optimal welding each time welding is performed even in a situation in which the impedance and the inductance of the welding circuit vary in each welding. This makes it possible to achieve an improvement in arc stability, a reduction in spatter yield, and an improvement in welding quality.

An arc welding robot system according to an embodiment has been described above. However, the present disclosure is not limited to the above-described embodiment and can be changed as appropriate without departing from the spirit thereof.

### EXPLANATION OF REFERENCE NUMERALS

1: Arc welding robot system
2: Robot
3: Arc welding machine
3a: Arc welding power supply
3b: Welding torch
3c: Welding wire
4: Robot controller
5: Parameter keeping device
6: Welding object
7: Welding fixture

What is claimed is:

1. An arc welding robot system comprising:
a robot;
an arc welding machine including a welding wire;
a robot controller; and
a parameter keeping device provided in either or both of the robot controller and the arc welding machine, wherein
an impedance and an inductance of a welding circuit are acquired in advance as parameters for each configuration of welding object and saved in the parameter keeping device, and
the robot controller performs welding control on each of the welding objects based on the impedance and the inductance saved in the parameter keeping device depending on the configuration of the welding object.

2. The arc welding robot system according to claim 1, wherein
in a case where the parameter keeping device provided in the arc welding machine keeps a plurality of sets of values of the parameters and the arc welding machine is to perform welding control based on the parameters, the robot controller specifies a set to be used among the plurality of sets for welding control, and
in a case where the arc welding machine does not keep a plurality of sets of values of the parameters and the arc welding machine is to perform welding control based on a single set of values of the parameters, the parameter keeping device provided in the robot controller keeps a plurality of sets of values of the parameters and transmits, to the arc welding machine, a set to be used among the plurality of sets for welding control.

3. The arc welding robot system according to claim 1, wherein
in a case where the robot controller keeps a plurality of sets of values of the parameters and the arc welding machine is not to perform welding control based on the parameters, the robot controller calculates, as optimal welding command values, a welding current value, a peak value and a base value in a welding current waveform based on a set to be used among the plurality of sets, and transmits the optimal welding command values to the arc welding machine for welding control.

4. The arc welding robot system according to claim 1, wherein
the parameter keeping device periodically acquires and saves the impedance and the inductance of the welding circuit, and
the arc welding robot system further comprises a failure determination section that determines a presence of a failure in the welding circuit when a change greater than or equal to a predetermined value occurs in the impedance and the inductance saved in the parameter keeping device.

5. The arc welding robot system according to claim 2, wherein
the parameter keeping device periodically acquires and saves the impedance and the inductance of the welding circuit, and
the arc welding robot system further comprises a failure determination section that determines a presence of a failure in the welding circuit when a change greater than or equal to a predetermined value occurs in the impedance and the inductance saved in the parameter keeping device.

6. The arc welding robot system according to claim 3, wherein
the parameter keeping device periodically acquires and saves the impedance and the inductance of the welding circuit, and
the arc welding robot system further comprises a failure determination section that determines a presence of a failure in the welding circuit when a change greater than or equal to a predetermined value occurs in the impedance and the inductance saved in the parameter keeping device.

7. The arc welding robot system according to claim 1, wherein the impedance and the inductance saved in the parameter keeping device are those acquired when welding is performed or those acquired when welding is not performed by moving the robot and bringing a tip of the welding wire included in the arc welding machine into contact with any of the welding objects.

8. The arc welding robot system according to claim 2, wherein the impedance and the inductance saved in the parameter keeping device are those acquired when welding is performed or those acquired when welding is not performed by moving the robot and bringing a tip of the welding wire included in the arc welding machine into contact with any of the welding objects.

9. The arc welding robot system according to claim 3, wherein the impedance and the inductance saved in the parameter keeping device are those acquired when welding is performed or those acquired when welding is not performed by moving the robot and bringing a tip of the welding wire included in the arc welding machine into contact with any of the welding objects.

10. The arc welding robot system according to claim 4, wherein the impedance and the inductance saved in the parameter keeping device are those acquired when welding is performed or those acquired when welding is not performed by moving the robot and bringing a tip of the welding wire included in the arc welding machine into contact with any of the welding objects.

11. The arc welding robot system according to claim 5, wherein the impedance and the inductance saved in the parameter keeping device are those acquired when welding is performed or those acquired when welding is not performed by moving the robot and bringing a tip of the welding wire included in the arc welding machine into contact with any of the welding objects.

12. The arc welding robot system according to claim 6, wherein the impedance and the inductance saved in the parameter keeping device are those acquired when welding is performed or those acquired when welding is not performed by moving the robot and bringing a tip of the welding wire included in the arc welding machine into contact with any of the welding objects.
